(19) United States
(12) Patent Application Publication
(10) Pub. No.: US 2014/0230890 A1
(43) Pub. Date: Aug. 21, 2014

(54) Dye-Sensitized Solar Cell with Metal Foam Electrode

(71) Applicant: CellMotive Co. Ltd., Seoul (KR)

(72) Inventors: Sunha Park, Seoul (KR); Yong-Hun Cho, Kyunggi-do (KR); Hyungyung Jo, Gyeonggi-do (KR); Myounggeun Choi, Gyeonggi-do (KR); Yung-Eun Sung, Kyunggi-do (KR); Heeman Choe, Kyunggi-do (KR)

(73) Assignee: CellMotive Co. Ltd., Seoul (KR)

(21) Appl. No.: 14/030,939

(22) Filed: Sep. 18, 2013

(30) Foreign Application Priority Data
Sep. 19, 2012 (KR) 10-2012-0104024

(51) Int. Cl. H01G 9/20; H01G 9/00

(52) U.S. Cl. CPC H01G 9/2022; H01G 9/0029
USPC 136/256; 438/98

(57) ABSTRACT

A dye-sensitized solar cell has a working electrode, electrolyte, and counter electrode. The counter electrode includes a nickel (Ni) foam, titanium (Ti) foam, manganese (Mn) foam, or molybdenum (Mo) foam, and has a surface that is nitrided. The reaction efficiency for the solar cell is enhanced by the increased surface area reacting with the electrolyte, which results from using a metal foam. Mechanical properties, such as strength and ductility, and electroconductivity are improved due to the use of metals. The production costs are reduced by using substitute materials, which are low-cost and have oxidation-reduction efficiency.

### CROSS-REFERENCE TO RELATED APPLICATIONS

This patent application claims the benefit of Republic of Korea patent application 10-2012-0104024, filed Sep. 19, 2012, which is incorporated by reference, along with an English translation of this application, and along with all other references cited in this application.

### BACKGROUND OF THE INVENTION

The present invention relates to solar cells and their method of manufacture, and more specifically, to a dye-sensitized solar cell including a metal foam electrode.

Due to mass consumption of fossil fuels, global environmental and energy problems, such as global warming and atmospheric pollution, will be the most significant issues to human beings even in twenty-first century. A solar cell is clean and directly converts infinite solar energy to the most efficient type of energy, and thus is available everywhere on earth. The solar cell is also expected to be the most fundamental solution for the energy and environment.

There is a need for improvements in solar cell technology, to improve efficiency, reliability, durability, longevity, and manufacturability, and reduce size, weight, and cost.

### BRIEF SUMMARY OF THE INVENTION

A dye-sensitized solar cell includes a working electrode, an electrolyte, and a counter electrode. The counter electrode can be a nickel (Ni) foam, a titanium (Ti) foam, a manganese (Mn) foam, or a molybdenum (Mo) foam, or any combination. The surface can be nitrided, instead of platinum or transparent conducting oxides (TCO) coated on the counter electrode.

### Problems To Be Resolved

The present invention was devised and aims at providing a dye-sensitized solar cell with improved reaction efficiency by increasing the surface area reacting with the electrolyte, which results from using a nickel (Ni) foam, a titanium (Ti) foam, a manganese (Mn) foam, or a molybdenum (Mo) foam, whose surface is nitrided, instead of platinum or transparent conducting oxides (TCOs) coated on the counter electrode.

An aspect of the present invention is to provide a dye-sensitized solar cell with improved mechanical properties, such as strength and ductility, prolonged lifespan and improved reliability and electroconductivity caused by the use of metals, and a method of manufacturing thereof.

An aspect of the present invention is to provide a dye-sensitized solar cell with reduced production costs by using low cost materials with oxidation-reduction efficiency, which can replace the conventionally used platinum or transparent conducting oxides (TCOs), and a method of manufacturing thereof.

### Means for Resolving the Problems

The present invention provides a dye-sensitized solar cell, including a working electrode, an electrolyte and a counter electrode, wherein the counter electrode comprises a metal foam whose surface is nitrided.

Further, the metal foam is manufactured by a dealloying process or an electroless plating process. Further, the metal foam has a mean pore diameter of 1 nanometer to 1 millimeter and porosity of 20 percent to 99 percent. Further, the metal form is at least one selected from a nickel (Ni) foam, a titanium (Ti) foam, a manganese (Mn) foam and a molybdenum (Mo) foam.

Further, the present invention provides a method of manufacturing a dye-sensitized solar cell, including a working electrode, an electrolyte and a counter electrode, where the method includes the steps of: (a) manufacturing a Ni—Mn alloy, which forms a full solid solution; (b) adding an acid solution to the alloy to remove manganese and manufacture a nickel foam; (c) nitriding a surface of the nickel foam; and (d) manufacturing a counter electrode comprising the nickel foam.

Further, in the above step (a), when manufacturing a nickel-manganese alloy, a ratio of nickel-to-manganese ranges from about 3:7 to about 5:5. Further, in the above step (b), the acid solution is at least one selected from HCl, HNO3, or H2SO4.

Further, the present invention provides a method of manufacturing a dye-sensitized solar cell, including a working electrode, an electrolyte and a counter electrode, where the method comprises the following steps: (a) plating a porous polymeric structure with a metal; (b) heat-treating the plated structure to remove the polymeric structure and manufacture a metal foam; (c) nitriding a surface of the metal foam; and (d) manufacturing a counter electrode comprising the metal foam.

Further, the above polymeric structure is at least one selected from PE (polyethylene), PET (polyethylene terephthalate), PTFE (poly-tetrafluoroethylene), or ABS Plastic. Further, in the above step (a), the heat-treatment temperature in the above step (b) ranges from about 200 to about 600 degrees Celsius. Further, in the above step (c), the surface is nitrided at a temperature ranging between about 300 and about 1000 degrees Celsius with ammonia.

Further, the above metal foam has a mean pore diameter of 1 nanometer to 1 millimeter and porosity of 50 percent to 99 percent. Further, the above metal is at least one selected from nickel (Ni), titanium (Ti), manganese (Mn), or molybdenum (Mo).

### Effect of the Invention

According to the present invention, it is possible to provide a dye-sensitized solar cell having the following features and a method of manufacturing thereof:

The reaction efficiency is enhanced by the increased surface area reacting with the electrolyte, which results from using a metal foam, such as a nickel (Ni) foam, a titanium (Ti) foam, a manganese (Mn) foam or a molybdenum (Mo) foam, whose surface is nitrided, instead of platinum or transparent conducting oxides (TCOs) coated on the counter electrode of the conventional dye-sensitized solar cell. Further, mechanical properties, such as strength and ductility, and electroconductivity are improved due to the use of metals, such as nickel, etc. Finally, the production costs can be reduced by using substitute materials, which are low-cost and have oxidation-reduction efficiency equivalent to that of the platinum/transparent conducting oxides (TCOs), as previously used.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 is a schematic view showing the structure of a conventional dye-sensitized solar cell.

FIG. 2 is a graph showing photocurrent density based on voltage when applying various processes of nickel (Ni) and platinum (Pt).

FIG. 3 is a schematic view showing the structure of a dye-sensitized solar cell according to the present invention.

FIG. 4 is an FESEM photograph of a solar cell for an example.

FIGS. 5A-5C show EDS experimentation results for an example.

FIG. 6 is a graph showing XRD results of a solar cell for an example.

FIGS. 7A-7B shows I-V curves of a solar cell for an example.

### DETAILED DESCRIPTION OF THE INVENTION

The present invention relates to a dye-sensitized solar cell, including a working electrode, an electrolyte and a counter electrode, wherein the counter electrode comprises a metal foam, whose surface is nitrided.

A dye-sensitized solar cell is a type of solar cell that converts sunlight to energy by copying the photosynthesis. Since high efficiency energy conversion is possible with less light as compared to the previous silicon solar cell and expensive semiconductor materials (e.g., silicon (Si)) or toxic materials (e.g., cadmium, and others) are not used, the dye-sensitized solar cell has recently been attracting attention as a next-generation solar cell technology. Specifically, the dye-sensitized solar cell can be manufactured in a translucent form to keep things distinct, and thus becomes a popular building integrated photo voltaic (BIPV) attached to the window, or other structure of a building.

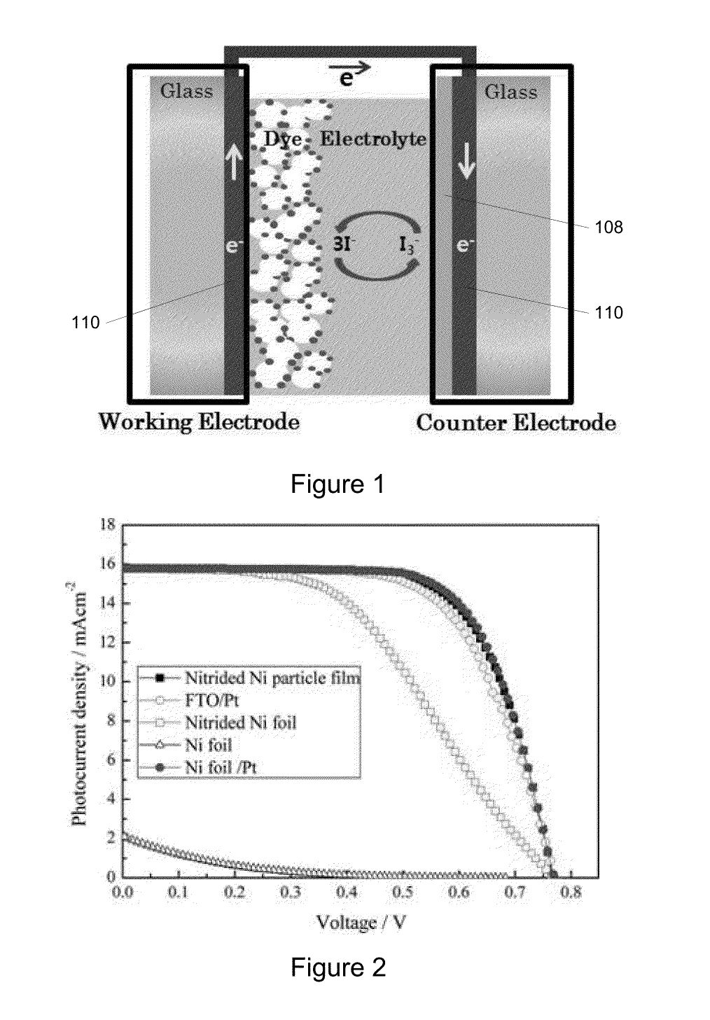

FIG. 1 shows a structure of a normal dye-sensitized solar cell. In terms of basic structure, the dye-sensitized solar cell has a sandwich structure including transparent electrodes (a working electrode, a counter electrode) coated on a transparent glass, porous titanium oxide (TiO2) particles, a dye adsorbed onto the TiO2 particles and an electrolyte solution for oxidation and reduction that fills a space having a thickness of about 50-100 microns between the two electrodes. The following describes the principles of the dye-sensitized solar cell having this structure.

First, when the sunlight passes through a transparent electrode of the dye-sensitized solar cell and irradiates a dye adsorbed onto a TiO2 nanocrystal, the dye absorbs the sunlight and the electrons of the dye are photoexcited from a ground state to an excited state. The excited electrons jump to a conduction band of TiO2, and the injected electrons are diffused through a porous TiO2 film to reach the transparent electrode. The electrons, which reached the electrode, move toward the counter electrode through an external circuit and generate electricity. On the contrary, the dye, which lost electrons to TiO2, obtains electrons from the electrolyte (iodide ion) to be reduced. Iodide is oxidized to iodine. Iodine obtains electrons from the counter electrode to also be reduced to iodide. By repeating this process, the solar cell is operated and the oxidation-reduction process is repeated.

The counter electrode of the transparent electrodes includes a platinum layer and a transparent conducting oxide (TCO) and is widely used in the field of electrochemistry (e.g., fuel cell, and others). However, platinum is expensive, and indium, used mainly in the transparent conducting oxide, is also very expensive. Moreover, these materials are limited, nonrenewable resources. Accordingly, research continues for replacing these materials with other materials that are less scarce.

The present invention relates to a metal foam layer that can replace platinum or transparent conducting oxides (TCO) coated on the counter electrode of the dye-sensitized solar cell. The platinum coated layer used in the conventional dye-sensitized solar cell is an indispensible layer required when converting triiodide ions (I3-) of the electrolyte to 3I-ions after receiving electrons from the counter electrode. However, platinum is very expensive, which is a principal reason for the relatively high production costs of a dye-sensitized solar cell. Indium, used for transparent conducting oxide (TCO), is also very expensive. Accordingly, the present invention helps reduce the production costs by replacing high cost platinum and transparent conducting oxides with low cost metal foams and to increase reliability by using a solid metal foam structure.

In order to replace the platinum layer coated on the counter electrode of a dye-sensitized solar cell, metal foams should be able to endure in an iodide electrolyte and have high electroconductivity and electrochemical activity. Further, metal foams should have reaction efficiency to replace the role of platinum, which includes absorbing sunlight to receive electrons and converting triiodide (I3-) of electrolyte to 3I-ions.

As materials satisfying such conditions, the present invention uses nickel (Ni), titanium (Ti), manganese (Mn), or molybdenum (Mo), whose surface is nitrided.

FIG. 2 is a graph showing photocurrent density based on voltage when applying various processes of nickel (Ni) and platinum (Pt) as an example. As shown, although efficiency of nickel (Ni) foil was considerably lower than that of the sample coated with platinum (Pt) in the example (Ni foil/Pt), efficiency of nitrided nickel (Ni) foil was improved and that of a nitrided Ni particle film was much better than that.

Accordingly, as a layer for replacing the platinum layer on the counter electrode according to the present invention, a metal foam having an open cell structure in a uniform shape rather than a particle film in a slurry type was used. Further, low oxidation-reduction properties of transition metals are complemented by nitriding a surface of metal, and the role of a transparent conducting oxide (TCO) can be replaced.

The metal foam according to the present invention can use various manufacturing processes, as previously known, without limitation, such as powder sintering, using a space holder, ice-template, dealloying, electroless plating, and electroplating. Specifically, it is desirable to manufacture a metal foam using dealloying or electroless plating.

In order to manufacture an open-cell foam, a powder processing in solid phase is most frequently used. Further, a process of removing the polymeric structure chemically or by heat after applying a metal ion to a structure (mainly, a polymeric structure), which can be by electroplating or an electroless plating.

The powder sintering process, as mentioned above, is most frequently used in order to manufacture an open-cell foam. According to this process, after compressing powder at room temperature, it is sintered at high temperature to form open-cell metal foam.

A process of using a space holder is a technology of forming pores by removing the space holder after mixing a space holder, which takes up space, with metal powder. For example, after heat-treating a mixture of salt particles with metal powder, the salt particles are removed using water. Polymeric particles or low melting metals, such as tin, magnesium, or zinc, may be used as a space holder.

An ice template is a process of forming a porous structure. Specifically, after mixing ceramic, a metal or a polymer powder with water, a binder, or other to form a slurry, a copper rod is placed in liquid nitrogen and the slurry is poured on it. Thereafter, only ice of a metal particle slurry frozen between ice is dried using a lyophilizer below freezing point. Spaces, where the ice was, become pores to form a porous structure. The porous structure is placed in a furnace and is sintered to form a porous metal foam. The ice template process has some advantageous, such as a directional porous structure can be obtained. Water or air in a fuel cell can smoothly flow such a directional porous structure.

A dealloying is a process used mainly for the manufacture of nanosized metal foam. Basically, two (or more) metal elements are prepared in a form of alloy. One of the metal elements is selectively etched using a certain etching solution to be removed. This forms a nanoporous material consisting of the remaining one metal element. In such case, a selective etching is possible when there some differences in an electrochemical potential between the two elements.

An electroless plating is a process, in which after pretreatment phase for applying a metal on a surface of a foam structure of a polymer, the polymer foam structure places in a solution containing metal ions, such as nickel, or others, to apply the metal on the surface, and the polymer is later removed using a chemical solution or heat treatment to manufacture a foam.

An electroplating is a process of plating a surface of an object using the principle of electrolysis, where a metal foam is manufactured from a polymer foam that is electroplated by directly applying electricity through a pretreatment process for making a surface of a polymer conductive. Although the electroplating process has advantages of a relatively fast plating speed and high purity of a plating layer, the plating thickness can be slightly nonuniform.

As one example of the present invention, a method of manufacturing a dye-sensitized solar cell using a nitrided nickel foam prepared by the described dealloying process is provided below.

A method of manufacturing a dye-sensitized solar cell, including a working electrode, an electrolyte and a counter electrode, where the method includes the steps of:

(a) manufacturing a nickel-manganese (Ni—Mn) alloy, which forms a full solid solution;

(b) adding an acid solution to the alloy to remove manganese and manufacture a nickel foam;

(c) nitriding a surface of the nickel foam; and

(d) manufacturing a counter electrode comprising the nickel foam.

In step (a), when manufacturing a nickel-manganese alloy, it is desirable that a ratio of Ni-to-Mn ranges from about 3:7 to about 6:4. Particularly, it is more desirable that the ratio of Ni-to-Mn ranges from about 3:7 to about 4:6 in order to secure a larger surface area. It is not desirable that the ratio is out of the above range, because it is difficult to form a three-dimensional structure when the amount of nickel is quite small, or it is difficult to manufacture a metal foam, in which nanosized pores are appropriately distributed, when the amount of nickel is quite large.

In step (b), the acid solution is at least one selected from hydrochloric acid (HCl), nitric acid (HNO3), and sulfuric acid (H2SO4).

Further, as another example of the present invention, provided below is a method of manufacturing a dye-sensitized solar cell including a working electrode, an electrolyte and a counter electrode, where the method includes the following steps:

(a) plating a porous polymeric structure with a metal;

(b) heat-treating the plated structure to remove the polymeric structure and manufacture a metal foam;

(c) nitriding a surface of the metal foam; and

(d) manufacturing a counter electrode including the metal foam, where the polymeric structure is at least one selected from PE (polyethylene), PET (polyethylene terephthalate), PTFE (polytetrafluoroethylene), and ABS Plastic.

It is desirable that the heat-treatment temperature in step (b) ranges from about 200 to about 600 degrees Celsius. Further, it is desirable that in the above step (c), the surface is nitrided at a temperature ranging between about 300 and about 1000 degrees Celsius with nitrogen or ammonia.

The nickel (Ni) foam according to the present invention has a mean size of 1 nanometer to 1 millimeter and porosity of about 20 percent to about 99 percent. The size and porosity of the foam are affected by the type and amount of a binder used for the manufacture of the porous foam, and also vary based on the temperature, stirring strength, and time during the manufacturing process.

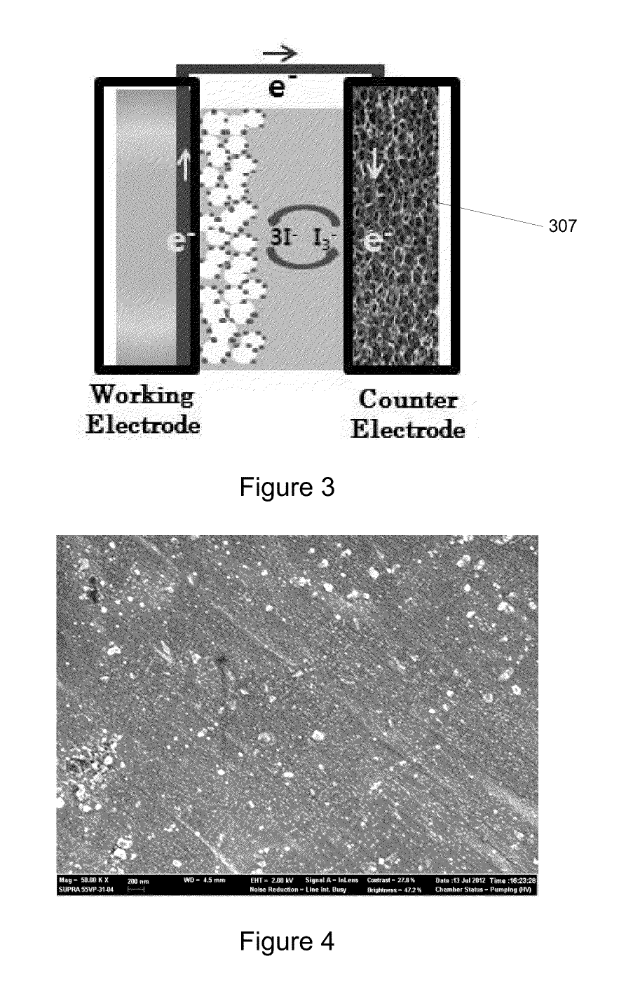

FIG. 3 is a schematic view showing the structure of a dye-sensitized solar cell according to the present invention.

As shown in the schematic view, instead of the platinum coating layer (a layer 108 in FIG. 1) and the transparent conducting oxide (TOC) (a layer 110 in FIG. 1), as previously used, a nickel foam with a nitrided surface is formed on a counter electrode 307. Accordingly, the production costs can be significantly reduced since high-cost platinum and indium do not have to be used when manufacturing a solar cell. Further, a similar oxidation-reduction efficiency to that of the electrode coated with a platinum layer can be obtained. Finally, mechanical properties, such as strength and ductility, and electroconductivity are enhanced due to the shape of a metal foam, and reaction efficiency can be improved by increasing the surface area reacting with the electrolyte, which results from the continued structure in an open-cell type.

For a structure of the metal foam applied to the counter electrode according to the present invention, it is general that a substrate is attached to one side of the nitrided metal foam with an open-cell structure, but various modifications are possible. As an example, when manufacturing a metal foam, a surface in contact with an electrolyte has an open-cell structure, but the other surface may consist of a metal foam layer alone without being attached to a separate substrate when being manufactured in a closed structure.

The present invention is described in more detail in the examples below. These examples are only to more specifically describe the present invention. It is obvious to one of ordinary skill in the art that the scope of the present invention according to the subject matter of the present invention is not limited to these examples.

### EXAMPLES

A dye-sensitized solar cell according to the present invention was manufactured by the following method.

A nickel foam used in this experimentation was manufactured through the steps of: plating a porous polymeric structure with a nickel metal; and heat-treating the plated structure to remove the polymeric structure and manufacture a nickel metal foam. After processing a sample having a required thickness from the manufactured nickel foams in bulk, a surface of the nickel foam is nitrided at a temperature of about 450 degrees Celsius in ammonia gas.

Thereafter, Surlyn(R) and the nickel foam were sequentially placed on a slide glass. By applying heat to the hot plate, Surlyn was melt to adhere the nickel foam to the glass substrate (for a counter electrode). Surlyn is a trademark of E. I. du Pont de Nemours and Company.

Surlyn resins are ionically cross-linked thermoplastics based upon ethylene copolymerised with carboxyl groups and a metal ion to give a unique material. They deliver impact toughness, abrasion resistance, and chemical resistance in a variety of consumer and industrial products, or use in other plastics as a modifier. In other implementations, other resins and thermoplastics are used.

In order to secure space for an electrolyte, a 50-micron spacer was placed thereon. After dropping Dyesol's Gel Electrolyte, a TiO2 electrode was placed thereon to form a cell. In other implementations, other electrolytes are used.

In order to confirm efficiency of the dye-sensitized solar cell, where a nitrided metal foam is applied to the counter electrode manufactured by the above method, the experimentation was conducted as set forth below.

FIG. 4 is a photograph of field emission scanning electron microscopy (FESEM) of a solar cell in the above example. The surface observed by FESEM showed that particles were gathered to form a thin film.

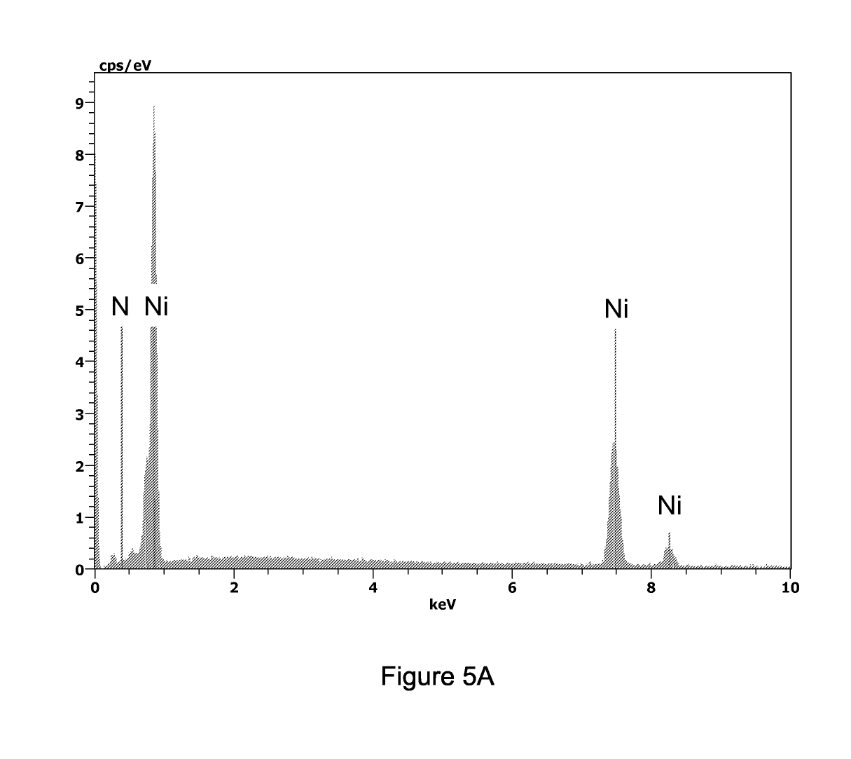

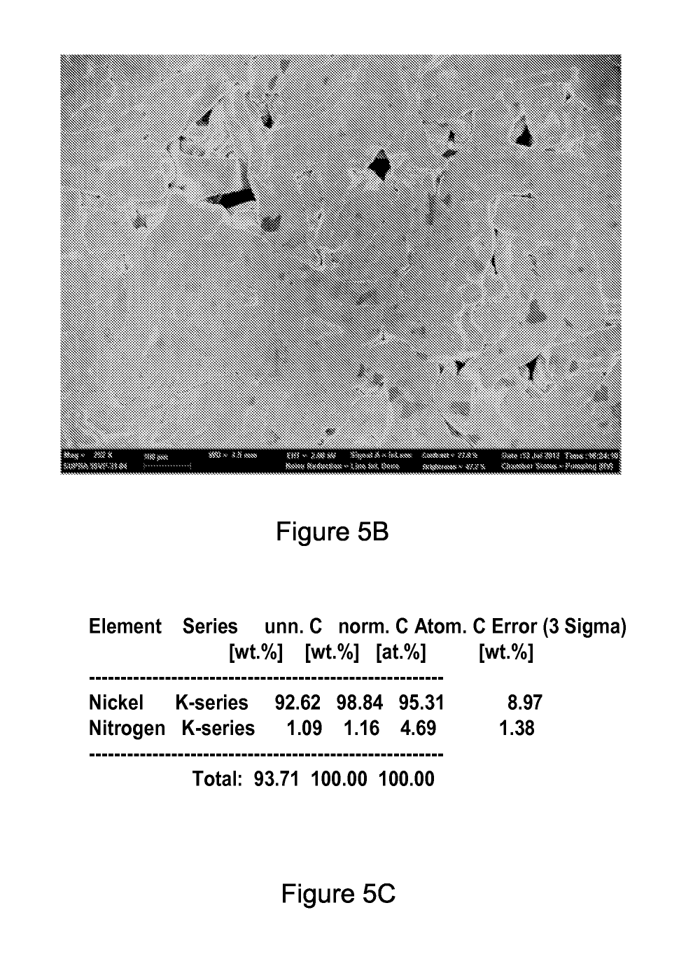

FIGS. 5A-5C show EDS experimentation results in the above example and showed that nickel was predominantly contained and nitrogen was contained in a small amount.

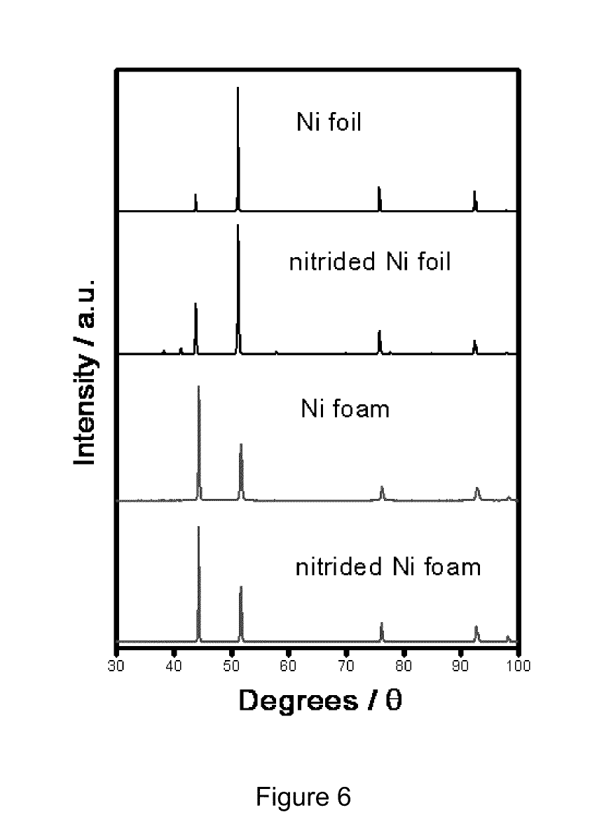

FIG. 6 is a graph showing the XRD results of a solar cell in the above example and showed that since nickel nitride was contained in a small amount on the surface, it was not significantly different from the nickel foam that was not nitrided.

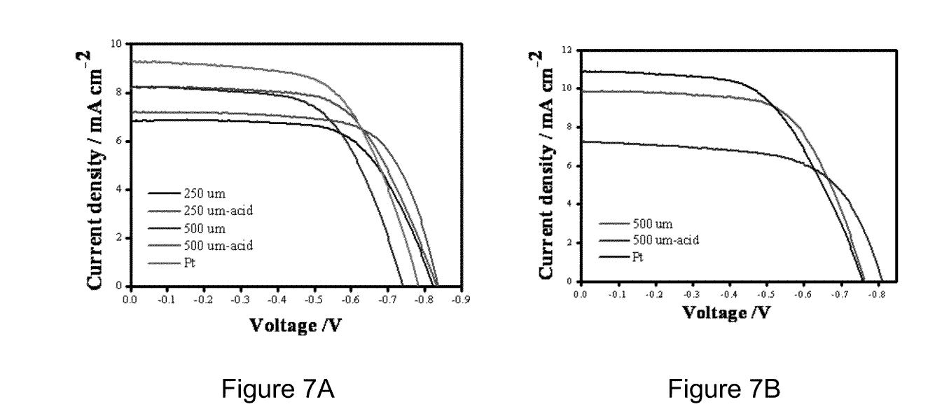

FIGS. 7A-7B show I-V curves. FIG. 7A shows an I-V curve for a nonscattering layer. FIG. 7B shows an I-V curve for a scattering layer. Samples had thicknesses of about 250 microns and about 500 microns. For different surface roughness, samples etched in an acid solution (e.g., about 250 microns-acid, about 500 microns-acid), samples not etched (e.g., about 250 microns, about 500 microns), and a sample using platinum were all included in the data. The results in the table below showed that the maximum efficiency was near 5 percent, which is over or similar to the efficiency of the previous solar cell using platinum.

TABLE

| | | V_{oc} | j_{sc} | FF | Eff. |
|---|---|---|---|---|---|
| Non- | 250 um | −0.82 | 6.83 | 0.65 | 3.64 |
| scattering | 250 um-acid | −0.83 | 8.19 | 0.62 | 4.23 |
| layer | 500 um | −0.74 | 8.26 | 0.61 | 3.75 |
| | 500 um-acid | −0.83 | 7.17 | 0.69 | 4.11 |
| | Pt | −0.78 | 9.27 | 0.62 | 4.46 |

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A dye-sensitized solar cell, comprising a working electrode, an electrolyte, and a counter electrode, wherein the counter electrode comprises a metal foam, whose surface is nitrided.

2. The dye-sensitized solar cell of claim 1, wherein the metal foam is manufactured by a dealloying process or an electroless plating process.

3. The dye-sensitized solar cell of claim 1, wherein the metal foam has a mean pore diameter from about 1 nanometer to about 1 millimeter and porosity from about 20 percent to about 99 percent.

4. The dye-sensitized solar cell of claim 1 wherein the metal foam is at least one selected from a nickel (Ni) foam, a titanium (Ti) foam, a manganese (Mn) foam, and a molybdenum (Mo) foam.

5. A method of manufacturing a dye-sensitized solar cell, comprising a working electrode, an electrolyte and a counter electrode, wherein the method comprises:
(a) manufacturing a nickel-manganese (Ni—Mn) alloy, which forms a full solid solution;
(b) adding an acid solution to the alloy to remove manganese and manufacture a nickel foam;
(c) nitriding a surface of the nickel foam; and
(d) manufacturing a counter electrode comprising the nickel foam.

6. The method of manufacturing a dye-sensitized solar cell according to claim 5 wherein when manufacturing the nickel-manganese alloy in (a), a ratio of Ni:Mn ranges from about 3:7 to about 6:4.

7. The method of manufacturing a dye-sensitized solar cell according to claim 5, wherein the acid solution in (b) is at least one selected from hydrochloric acid, nitric acid, and sulfuric acid.

8. A method of manufacturing a dye-sensitized solar cell, comprising a working electrode, an electrolyte and a counter electrode, wherein the method comprises:
(a) plating a porous polymeric structure with a metal;
(b) heat-treating the plated structure to remove the polymeric structure and manufacture a metal foam;
(c) nitriding a surface of the metal foam; and
(d) manufacturing a counter electrode comprising the metal foam.

9. The method of manufacturing a dye-sensitized solar cell as claimed in claim 8, wherein the polymeric structure is at least one selected from PE (polyethylene), PET (polyethylene terephthalate), PTFE (poly-tetrafluoroethylene), and ABS Plastic.

10. The method of manufacturing a dye-sensitized solar cell as claimed in claim 8 wherein the heat-treatment temperature in the above step (b) ranges from about 200 degrees Celsius to about 600 degrees Celsius.

11. The method of manufacturing a dye-sensitized solar cell as claimed in claim 5 wherein in the above step (c), the surface is nitrided at a temperature ranging from about 300 degrees Celsius to about 1000 degrees Celsius with nitrogen or ammonia.

12. The method of manufacturing a dye-sensitized solar cell as claimed in claim 8 wherein in the above step (c), the surface is nitrided at a temperature ranging between about 300 and about 1000 degrees Celsius with nitrogen or ammonia.

13. The method of manufacturing a dye-sensitized solar cell as claimed in claim 5 wherein the metal foam has a mean pore diameter from about 1 nanometer to about 1 millimeter and porosity from about 20 percent to about 99 percent.

14. The method of manufacturing a dye-sensitized solar cell as claimed in claim 8 wherein the metal foam has a mean pore diameter from about 1 nanometer to about 1 millimeter and porosity from about 20 percent to about 99 percent.

15. The method of manufacturing a dye-sensitized cell as claimed in claim 8 wherein the metal is at least one selected from nickel (Ni), titanium (Ti), manganese (Mn), and molybdenum (Mo).
